(19) United States
(12) Patent Application Publication
(10) Pub. No.: US 2015/0231835 A1
(43) Pub. Date: Aug. 20, 2015

(54) FIBRE ORIENTATION OPTIMISATION

(71) Applicant: AIRBUS OPERATIONS LIMITED, Bristol (GB)

(72) Inventor: Jago Pridie, Bristol (GB)

(73) Assignee: AIRBUS OPERATIONS LIMITED, Bristol (GB)

(21) Appl. No.: 14/434,581

(22) PCT Filed: Oct. 16, 2013
(86) PCT No.: PCT/GB2013/052696

§ 371 Date: Apr. 9, 2015

(30) Foreign Application Priority Data
Oct. 18, 2012 (GB) 1218720.9

(51) Int. Cl. B29C 70/38; B29C 51/14; B29D 99/00; B29C 51/10

(52) U.S. Cl. CPC B29C 70/384; B29C 51/10; B29C 51/145; B29D 99/0025; B29K 2063/00

(57) ABSTRACT

The present application is concerned with methods of determining optimised fibre paths for complex composite components manufactured from multiple layers of composite material, particularly such components manufactured using an automated fibre placement (AFP) process. One aspect provides a method of determining an optimised fibre path for a geometrical feature of a composite component comprising a plurality of layers of composite material, each layer of composite material comprising a plurality of unidirectional fibres embedded in a matrix. The method includes manufacturing a test piece by: laying up a plurality of composite plies to form a planar charge, each composite ply comprising a plurality of unidirectional fibres embedded within a matrix; and shaping the planar charge by forming it over a mandrel using a hot drape forming process, the shaped charge having a shape corresponding to the geometrical feature of the composite component. Then, at each of one or more datum points, measuring a direction of the unidirectional fibres of one of the plurality of composite plies of the manufactured test piece with respect to a local coordinate system of said datum point. An optimised fibre path for the geometrical feature is determined based on the one or more measured fibre directions of said one of the plurality of composite plies.

### FIELD OF THE INVENTION

The present invention relates to methods of optimising the fibre directions at geometrical features of composite components, particularly composite components formed by an automated fibre placement (AFP) process.

### BACKGROUND OF THE INVENTION

Many complex composite components are manufactured by processes of lamination of layers of composite material. One method known as vacuum bag forming involves the laying up of planar layers (or plies) known as pre-pregs, each comprising a plurality of unidirectional fibres embedded within a matrix, one by one into or onto a female or male mould tool. A vacuum and, optionally, heat is applied to consolidate the laid up plies so that they assume the shape of the mould. A related method known as drape forming includes first forming a planar stack of plies, known as a charge or plaque, and draping the planar charge over a tool, usually a male tool, and applying a pressure differential to shape the charge to the tool. Hot drape or diaphragm forming involves the application of heat to the stack before or during the process of applying the pressure differential. Various drape forming methods are described in our earlier application WO2009/044194.

Automated fibre placement (AFP) is a manufacturing method which has similarities to vacuum bag forming or drape forming methods, but a key difference is that the pre-preg layers are typically laid in their final position on the mandrel, rather than being subjected to shape forming after lay-up. Thus, fibre placement is typically used to lay up parts with geometry which would be subject to wrinkles if produced using a drape forming or conventional hand laying process. The pre-preg layers typically comprise narrow tapes known as tows, each tow having multiple unidirectional fibres embedded in a matrix. Once the pre-preg layers have all been laid up on the mandrel the formed charge is usually consolidated via a vacuum bagging process, either in situ on the mandrel or on another matching male or female tool, and then cured, optionally in an autoclave. The AFP process may alternatively be used to lay up a planar charge which may subsequently be mechanically folded or formed, particularly in cases where it is a requirement for the planar charge to have a high degree of angular deviation between fibres within a ply. The AFP process can also be used for dry fibre placement, the placed fibres subsequently being infused with a resin via vacuum or resin transfer moulding (RTM) type processes.

Automated fibre placement can be used to form more complex shapes than known vacuum bagging or drape forming techniques. In particular, AFP methods are used to form composite spars for aircraft wings, such spars significantly tapering in height along their length and having many complex geometrical features such as upper and lower flanges (known as caps), joggles (at joints), and ramps (to cater for changes of thickness). However, using current modelling methods it is difficult to predict the optimal fibre orientations for such complex geometrical features, and in particular at the junctions between such features. An unwanted result of non-optimal fibre orientations is wrinkles, which typically form around such geometrical features and are not apparent prior to cure. Wrinkles are typically caused by out of plane movement by the fibres of one of more of the tows.

Known methods of avoiding such wrinkles include validation of computer simulations by performing multiple lay-up and cure trials using the AFP process. Such methods are undesirable because they involve the use of expensive AFP machines and other resources, and are very time-consuming.

### SUMMARY OF THE INVENTION

The present inventor has found that it is possible to form test pieces representing the various discrete problematic geometrical features of complex composite components, such as a spar of an aircraft wing, without any wrinkles by forming a planar charge on a representative tool. That is, the forming process enables each fibre to move sufficiently relative to its neighbours to achieve an arrangement in which the local stresses and inconsistencies which typically cause wrinkles are minimised. Each fibre thus moves within its respective ply so that it follows its ‘optimised’ trajectory, or natural path.

The inventor has developed a method of analysing the movement of the fibres within those test pieces to determine the ‘optimised’ trajectory of a fibre path within a particular geometrical feature. This information can be used, for example, to inform the process of designing fibre orientations for a component which is to be manufactured by an AFP process.

Thus, a first aspect of the invention provides a method of determining an optimised fibre path for a geometrical feature of a composite component comprising a plurality of layers of composite material, each layer of composite material comprising a plurality of unidirectional fibres embedded in a matrix, the method including the steps of:
manufacturing a test piece by: laying up a plurality of composite plies to form a planar charge, each composite ply comprising a plurality of unidirectional fibres embedded within a matrix; and shaping the planar charge by forming it on a tool, the shaped charge having a shape corresponding to the geometrical feature of the composite component;
at each of one or more datum points, measuring a direction of the unidirectional fibres of one of the plurality of composite plies of the manufactured test piece with respect to a local coordinate system of said datum point; and
determining an optimised fibre path for the geometrical feature based on the one or more measured fibre directions of said one of the plurality of composite plies.

The inventor has identified the surprising effect that the localised movements of the fibres of the test piece during the forming process allow those fibres to find their ‘natural’ or ‘optimised’ positions within the ply. Such an optimised position has been found to minimise, or altogether avoid, unwanted wrinkles occurring during cure. This is particularly the case in regions of complex shape, such as those at or between geometrical features such as radii, joggles and ramps. The localised fibre movements may include both in-plane translation and in-plane rotation of fibres. In-plane rotation of fibres may be caused by the ‘sweeping motion’ of drape forming methods.

The method of the present invention avoids the drawbacks of known methods of optimising fibre paths since there is no requirement to prepare multiple test pieces to determine an optimised fibre path by an iterative process, and since the test piece is not produced using an expensive AFP process, but instead by a relatively inexpensive forming process, such as hot drape forming (HDF). Moreover, the results achieved using the present method are significantly better than those achieved using known computer simulation techniques. The results achieved using the present method may in fact be used to improve such computer simulation techniques.

The method may be used for pre-production optimisation of a composite component. For example, the test piece may comprise a pre-production ‘non-flying’ part, or even one of the first batch of production parts.

The layers of composite material of the composite component preferably each comprise one or more tows for laying up by an automated fibre placement process. Thus, the optimised fibre orientations determined from the relatively inexpensive formed test piece can be used to inform the process of designing the fibre orientations of a relatively expensive AFP formed component. Moreover, in the case of components which are geometrically too complex to be formed in one piece by a forming process and must instead be formed by an AFP process, the present method may still be used since the test piece may represent only a particular portion of the complex component that is able to be formed by a forming process such as hot drape forming.

Alternatively, the layers of composite material of the composite component may each comprise one or more plies for laying up by a drape forming process such as a hot drape forming process. Thus, the method may be used for pre-production development of parts, and manufacturing optimisation.

The one or more of the plurality of composite plies of the test piece may each include one or more detectable yarns aligned with the unidirectional fibres of that ply, and the step of measuring a direction of the unidirectional fibres may include detecting said one or more yarns and determining an angular deviation of the one or more yarns relative to each of the local coordinate systems.

Preferably, the one or more yarns comprise an x-ray detectable material, and the step of detecting said one or more yarns includes taking an x-ray image of the test piece in which the yarns are visible. In this way, the optimised fibre paths can be determined without destruction of the test piece and by a relatively quick and simple process of analysis.

Alternatively, in embodiments in which the fibres of the plurality of composite plies of the test piece comprise glass fibres, the one or more detectable yarns may each comprise coloured material such as a coloured thread or string. For example, each composite ply having a particular fibre orientation may include a detectable yarn of a colour corresponding to that fibre orientation (0°, 45°, 90° or 135°, for example). In this way, the translucent nature of the glass fibres will allow the coloured yarns to be detected visually, with different coloured yarns indicating the fibre positions of a particular fibre orientation.

Alternative methods of measuring a direction of the unidirectional fibres may include using ultrasonic methods such as ultrasonic backscattering methods, or any other suitable scanning technique. Another method may include peeling away each ply one-by-one and determining fibre direction by visual inspection.

Each local coordinate system preferably comprises a reference marker (e.g. a rosette) formed on the mandrel, the reference marker comprising one or more vectors extending from the respective datum point. Each vector preferably corresponds to an expected direction of the unidirectional fibres of one or more of the composite plies of the test piece at that datum point. Each reference marker preferably comprises at least one of: a vector corresponding to a 0° fibre direction; a vector corresponding to a 45° fibre direction; a vector corresponding to a 90° fibre direction; and a vector corresponding to a 13520 fibre direction. In this way, a single x-ray image, or other image, in which both the reference marker and yarns are visible can be used to directly compare the yarn direction with the local coordinate system.

In alternative embodiments the local coordinate systems may have no physical presence, but instead may comprise virtual local coordinate systems within a detection system comprising detection apparatus for determining a fibre direction at each datum point. Thus, the detection system could provide an automated (computational) means of comparing the detected fibre direction with a virtual local coordinate system.

Alternatively, the step of manufacturing the test piece may include providing the local coordinate system by forming a reference marker on the tool and transferring the reference marker to the tool during shaping of the planar charge on the tool. Thus, inspection of the fibre orientations may be carried out after removal of the test piece from the tool. In embodiments in which the fibres of the composite plies of the test piece comprise glass fibres and the detectable yarns comprise coloured threads or strings, the inspection may be carried out by shining a light source through the test piece and the results recorded via a conventional optical photograph or similar.

The matrix of the composite plies of the test piece preferably comprises a thermosetting epoxy resin. That is, the matrix preferably has a viscosity which decreases with increasing temperature, reaches a minimum level pre-cure and increases to a maximum level post-cure. Alternatively, the matrix of the composite plies of the test piece may comprise a thermoplastic resin.

The matrix of the composite plies of the test piece is preferably a toughened epoxy resin, i.e. an epoxy resin comprising a toughener material such as a thermoplastic toughener material. The matrix most preferably comprises substantially no un-dissolved toughener material. That is, the matrix preferably comprises a substantially wholly dissolved toughener material. Thus, the matrix may have a low degree of frictional resistance to fibre movement within the matrix, thereby enabling fibres to achieve their optimised orientations without out of plane movement which may lead to wrinkles. A suitable matrix material is CYCOM™ 977-2 resin, produced by Cytec Industries, Inc.

The fibres of the composite plies of the test piece preferably have a uniform cross-sectional shape. Suitable fibres include HTS fibres. Such fibres may minimise the resistance to fibre movement in-plane within the matrix, and thereby help to enable the fibres to achieve an optimised orientation without out of plane movement which may lead to wrinkles.

The fibres of the composite plies of the test piece are preferably carbon fibres, but may alternatively be glass fibres; in particular, glass fibres having a uniform circular cross-sectional shape. Such glass fibres may minimise resistance to in-plane fibre movement within the test piece, thus enabling the fibres to achieve their optimised orientation without out of plane movement which could lead to wrinkles.

A second aspect of the invention provides a method of manufacturing a composite component having a geometrical feature and comprising a plurality of layers of composite material, each layer of composite material comprising a plurality of unidirectional fibres embedded in a matrix, the method including the steps of:
determining the optimised fibre path for the geometrical feature using the method of the first aspect; and
laying up the plurality of layers of composite material to form the composite component, a direction of the unidirectional fibres of one or more of the layers of composite material at each datum point corresponding to the optimised fibre path.

In this way, the fibre paths of the composite component can be optimised without performing multiple time-consuming and expensive trials by an iterative process. Instead, the data derived from the method of the first aspect can be directly applied to the composite part.

The composite component may be formed by an automated fibre placement (AFP) process. Thus, each of the layers of composite material may comprise one or more tows, and the step of laying up the plurality of layers of composite material may include laying up the tows using an automated fibre placement process. In this way, the fibre paths of a comparatively expensive AFP-produced component can be optimised using a comparatively inexpensive forming method such as hot drape forming. Moreover, this can be achieved without performing multiple time-consuming and expensive trials to arrive at an optimised fibre path by an iterative process. In the case of components which are geometrically too complex to be formed in one piece by a forming process and must instead be formed by an AFP process, the present method may still be used since the test piece may represent only a particular portion of the complex component that is formable.

Alternatively, the composite component may be formed by a drape forming process, such as a hot drape forming process. Thus, the step of laying up the plurality of layers of composite material may include laying up the plurality of layers of composite material to form a planar charge and shaping the planar charge on a tool.

The matrix of the composite plies of the test piece preferably has a lower frictional resistance to fibre movement than the matrix of the plurality of composite layers of the composite component. In other words, the composite plies of the test piece preferably have a lower inter-ply friction (i.e. the frictional force resisting movement of the fibres of one ply relative to a neighbouring ply) than the plurality of layers of the composite component. Thus, the lower friction within the test piece plies enables the fibres to move locally in-plane to achieve their optimised orientations. In embodiments in which the composite component is produced by an AFP process, such fibre movement is not possible in the tows of the AFP-produced component because it is prevented by the higher inter-matrix friction. In addition, there is no hot drape forming ‘sweeping’ motion to induce in-plane rotation of discrete plies.

For a hot drape forming process the frictional resistance of the matrices may be compared at a temperature of the process, such as a maximum temperature of the process. To achieve the lower frictional resistance of the matrix of the test piece, the matrix may comprise substantially no un-dissolved toughener material, whereas the matrix of the plurality of tows of the composite component may comprise un-dissolved toughener material. A suitable material for the matrix of the composite component is HexPly™ M21 or M21E, produced by Hexcel™, while a suitable matrix material for the test piece is CYCOM™ 977-2 resin, produced by Cytec Industries, Inc.

The fibres of the layers of the composite component are preferably carbon fibres, whereas the fibres of the composite plies of the test piece may be carbon fibres or glass fibres. In embodiments in which the fibres of the test piece are glass fibres, those fibres preferably have a circular cross-sectional shape. In this way, resistance to in-plane movement of the glass fibres may be minimised, thus enabling the glass fibres to more easily achieve their optimised orientations without out of plane movement which could lead to wrinkles.

The composite component is preferably a spar of an aircraft wing. Such components are typically large and geometrically very complex. It has in the past been difficult to determine optimised fibre paths because of the numerous and various geometric features of a spar, such as caps, ramps, joggles and radii. The present invention enables optimised fibre paths for such features to be determined by a relatively simple, inexpensive and accurate method.

A third aspect of the present invention provides a method of providing a set of design rules for determining optimised fibre paths of a composite product comprising a plurality of geometrical features, the method including the steps of:
for each of the plurality of geometrical features, determining an optimised fibre path using the method of the first aspect; and
compiling the optimised fibre paths of the geometrical features to provide a set of design rules for fibre paths of a composite product.

The set of design rules can thus be used to design a composite component with a fully optimised set of fibre orientations. This is particularly advantageous where the composite component is produced via an AFP process, but could be applied to component produced by a drape forming process such as hot drape forming.

The plurality of geometrical features preferably includes one or more of the following: ramps, joggles, and radii. In embodiments where the composite component is a spar of an aircraft wing the geometrical features may include wing curvature and spanwise taper.

A fourth aspect of the invention provides a method of measuring a fibre orientation of a composite component, the composite component comprising a plurality of composite plies laid up to form a charge, and each composite ply comprising a plurality of unidirectional fibres embedded within a matrix, the method including:
providing one or more detectable yarns in one or more of the composite plies, each of the yarns being aligned with the unidirectional fibres of the respective ply;
providing a local coordinate system; and
producing an image of the composite component, and using that image to determine an angular deviation of the one or more yarns relative to the local coordinate system.

This method provides a non-destructive technique for determining the fibre orientations of a charge. It is important to be able to determine such fibre orientations so as to verify whether the fibre paths are orientated within acceptable tolerances (as an example, tolerances of ±35° are typical in aircraft primary structure applications). The method can also be used to inform future design decisions.

The composite component may be a pre-production test piece, or may alternatively be a production part which is to be inspected for quality control or stress analysis purposes, or which is to be subjected to a mechanical testing process.

The detectable yarns preferably comprise x-ray detectable material, and the image is preferably an x-ray image. Alternatively, the detectable yarns may comprise coloured material, and the image may comprise an optical image in which the coloured material is visible to the human eye.

The method may include forming the charge on a forming tool such as a mandrel before producing the image. Thus, the method may serve to detect changes in fibre orientation caused by the forming process.

Each local coordinate system preferably comprises a vector extending from its respective datum point and aligned with an expected direction of the unidirectional fibres of one or more of the composite plies at that datum point. In preferred embodiments each local coordinate system comprises an x-ray detectable reference marker (e.g. a rosette) formed on the forming tool. The reference marker preferably includes x-ray detectable material defining the datum point and vector. Alternatively, each local coordinate system may comprise a reference marker formed on the forming tool and arranged to be transferred from the forming tool to the composite component. Such a reference marker may comprise x-ray detectable material for viewing in an x-ray image, or coloured material for viewing in an optical image.

In any of the first to fourth aspects of the invention the test piece (of the first, second and third aspects) or composite component (of the fourth aspect) may be cured. The curing process serves to ‘freeze’ the fibres in situ for subsequent analysis. This is particularly relevant to embodiments in which inspection of fibre orientation is carried out after removal of the laminate from the forming tool. The test piece or composite component may be cured in an autoclave, but a lower temperature curing process may be appropriate since high the levels of porosity and lack of consolidation associated with lower temperature curing should have no consequence on the fibre orientations. The cost of a lower temperature curing process is considerably lower than that of an autoclave process, and low temperature curable resins may therefore be preferred.

A fifth aspect of the present invention provides a forming tool (e.g. a mandrel) adapted for use with the method of any of the preceding claims, the forming tool including:
a tool surface for shaping the charge;
a plurality of reference markers formed on the tool surface, each reference marker including a datum point and one or more vectors extending from the datum point (each vector preferably corresponding to an expected direction of the unidirectional fibres of one or more of the composite plies of the charge at that datum point), and each reference marker being detectable through a charge by a scanning device.

The reference markers are preferably detectable by an x-ray detector, and may include material that is detectable by an x-ray detector.

The tool surface of the forming tool may comprise a female tool surface but preferably comprises a male tool surface, whereby the charge can be draped over the male tool surface to be formed.

A sixth aspect of the present invention provides apparatus for use with the method of the first, second, third or fourth aspects, including:
a forming tool according to the fifth aspect;
a scanning device arranged to detect the plurality of reference markers of the mandrel.

The scanning device preferably comprises an x-ray source and an x-ray detector arranged with the tool surface of the mandrel therebetween.

Any of the features discussed above or below in relation to any aspect of the invention may be applied to any of the aspects of the invention, either alone or in any combination.

### BRIEF DESCRIPTION OF THE DRAWINGS

Embodiments of the invention will now be described with reference to the accompanying drawings, in which:

FIG. 1 illustrates an isometric view of an aircraft wing spar;

FIG. 2 illustrates a simplified unfolded aircraft wing spar showing the design intent for a deviation from nominal of 0° fibre paths to achieve a compromise between geometry constraints such as taper and curvature, but which has not yet been fully optimised for manufacture;

FIG. 3 illustrates the configuration of a charge for manufacture of a test piece according to an embodiment of the present invention;

FIG. 4 shows an example mandrel according to an embodiment of the present invention; and

FIG. 5 illustrates a fibre orientation detection process according to an embodiment of the present invention.

### DETAILED DESCRIPTION OF EMBODIMENT(S)

The starting point for design of the fibre directions within a complex composite component, such as a spar for an aircraft wing, is to optimise the fibre paths for stress requirements, part quality and deposition rates. However, the fibre path may have to deviate from nominal locally in order to traverse difficult geometrical features, resulting in a compromise between stress and manufacturing requirements.

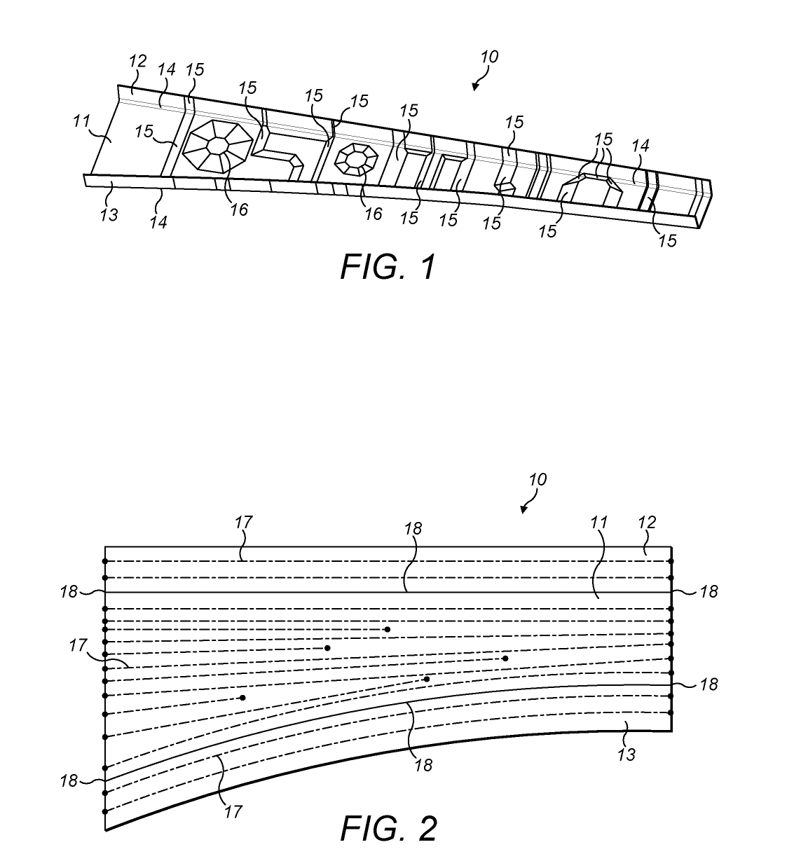

An example of an aircraft wing spar 10 is shown in FIG. 1. The spar 10 has an elongate spanwise-extending web 11 and upper 12 and lower 13 caps (flanges). The caps 12, 13 extend generally at right angles to the web 11, and are connected via radii 14. The web 11 and caps 12, 13 each have multiple regions of different thickness, and ramps 15 which connect such regions. The web 11 also has localised pads 16 which are regions of increased thickness surrounded by ramped regions within which the web thickness tapers. The spar 10 also may have one or more joggles (not shown) which include a change in profile shape required to achieve a lap joint with, or traverse a features such as a local pad-up of, an adjacent structure such as a wing skin (not shown). The radii 14, ramps 15 and joggles are examples of geometrical features at which wrinkles can commonly form during curing, particularly when the spar 10 is formed by an automated fibre placement (AFP) process or hot drape forming process.

The spar 10 tapers in height along its length, which means that the 0° fibres which nominally extend along the length of the spar (i.e. spanwise) have to deviate from this nominal direction in the caps and in the regions of the web near to the caps, as illustrated by the deviated fibre paths 17 shown in FIG. 2, which is a simplified view showing an unfolded spar with no features other than a web 11 and upper 12 and lower 13 caps. The heel lines 18 denote the interface between the web 11 and the caps 12, 13. Of course, locally the fibres must deviate even further from the arrangement shown in FIG. 2 to accommodate the radii 14, ramps 15 and joggles of a typical spar 10 such as that illustrated in FIG. 1.

The present invention proposes a method for determining the optimised fibre paths for geometrical features such as the radii 14, ramps 15 and joggles, and the interconnecting regions between them.

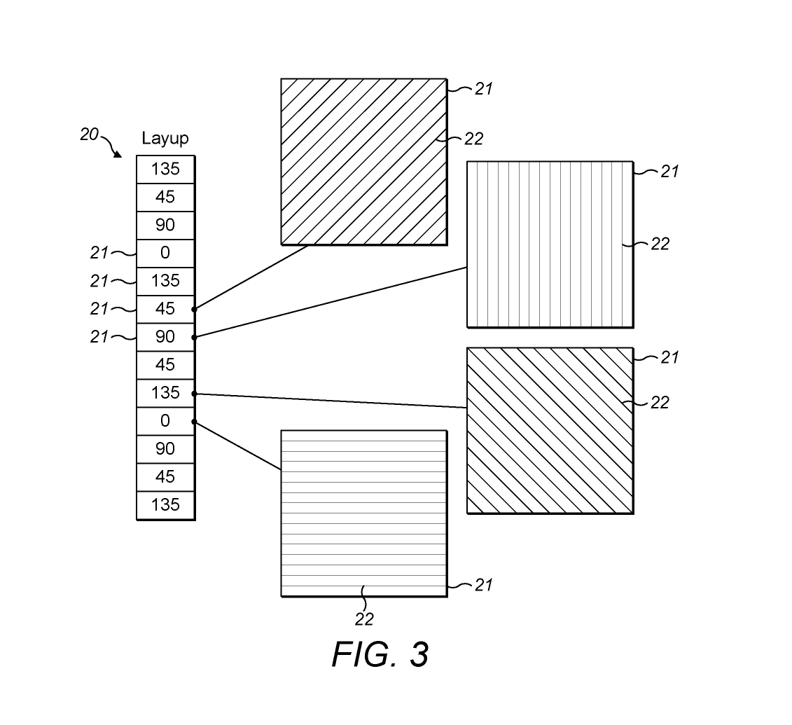

A test piece (not shown) is formed by first laying up a charge 20 (or plaque) comprising a stack of pre-preg sheets 21 having orientations as shown in FIG. 3. Each pre-preg sheet 21 has unidirectional fibres (not shown) oriented at either 0°, 45°, 90° or 135° (−45°) and embedded within a matrix (not shown). One or more of each of the pre-preg sheets 21 at each of the four orientations is adapted by the addition of an x-ray detectable yarn 22 such as a barium sulphate yarn (a preferred yarn is a Micropake™ yarn produced by Speciality Fibres and Materials Ltd.) aligned with the fibres of the respective pre-preg sheet 21. The charge 20 can be laid up by hand or by an automated process such as by using a tape laying machine. In embodiments where the charge is laid up using a tape laying machine the x-ray detectable yarns 22 can be arranged between neighbouring tape strips. The yarn 22 is selected to have a thickness which is not greater than the thickness of each ply, in order to not itself promote wrinkle formation.

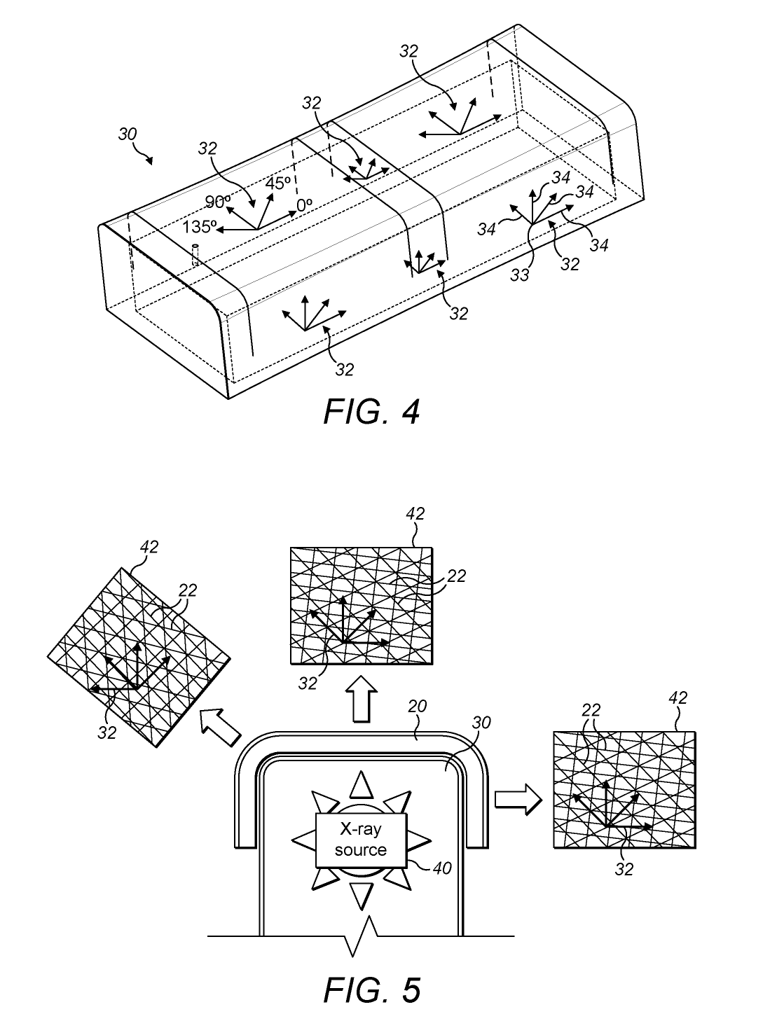

The charge 20 is then placed over a mandrel 30 (a representative example of which is shown in FIG. 4) in order to shape it such that the shape of the test piece corresponds to the shape of the spar 10, a section thereof, or a portion thereof including one or more of the geometrical features of the spar 10, such as the radii 14, ramps 15, and joggles. The outer surface (tool surface) of the mandrel 30 thus has a shape corresponding to the desired shape of the inner surface of the test piece.

The charge 20 is shaped using a hot drape forming process, which includes applying heat and a vacuum to the charge in order to make its shape conform to that of the mandrel 30. The set up for the hot drape forming process (not shown) includes sandwiching the planar charge 20 between release films and supporting the charge on a support membrane (a suitable material being Vacfilm 430, manufactured by Aerovac Systems Ltd) resting on the mandrel 30 and suspended between two edge bars or sweeper blocks arranged either side of the mandrel 30. The support membrane is fixed to the edge bars/sweeper blocks by tape, and serves to prevent the charge forming prematurely during heat up and provides tension to the underside of the charge during forming. A diaphragm is draped over the assembly, optionally with a breather layer between it and the charge.

During the hot drape forming process a vacuum is applied to the assembly so that the volume between the diaphragm and the mandrel 30 is evacuated. The diaphragm is therefore drawn towards the tool surface of the mandrel 30 so that the charge 20 is progressively deformed so that it conforms to the shape of the tool surface. During the deformation process the charge 20 is typically heated to a temperature of approximately 80° C. at a rate of 5° C. per minute, but the temperature profile will depend on the type of pre-preg sheet selected. This temperature increase causes the viscosity of the resin (matrix) within the charge 20 to decrease, so permitting a limited degree of movement of the fibres. The temperature is then ramped up in order to cure the part when the forming cycle is complete.

Hot drape forming methods are further described in our earlier application WO2009/044194, which is hereby incorporated by reference.

During the hot drape forming process the fibres of each of the pre-preg sheets 21 are able to move locally in order to achieve an arrangement in which the local stresses and inconsistencies which typically cause wrinkles are minimised. Each fibre thus follows its ‘optimised’ path at completion of the hot drape forming process.

The pre-preg sheets used for the test piece in the present embodiment incorporate CYCOM™ 977-2 resin, which is a 177° C. curing toughened epoxy resin manufactured by Cytec Industries, Inc. It is believed that the comparatively low frictional resistance to in-plane fibre movement provided by this resin allows the fibres to re-orientate in plane (i.e. within the ply, or by permitting relative movement between plies) rather than out of plane (i.e. to form a wrinkle). This low frictional resistance is believed to be a result of the lack of un-dissolved toughener material within the resin. Other comparable resins which include such un-dissolved toughener material, such as those typically used for AFP processes, demonstrate a higher detree of frictional resistance to the in-plane movement of fibres. Although CYCOM™ 977-2 resin has been used in this embodiment, any resin which contains substantially no un-dissolved toughener may be suitable.

The formed test piece is then analysed to determine the new, optimised, fibre paths. In particular, the analysis focuses on regions of the test piece which represent a geometrical feature of interest, or a transition region between such geometrical features. In this embodiment the analysis is performed by taking an x-ray image of the test piece, and scrutinising the positions of the x-ray detectable yarns 22.

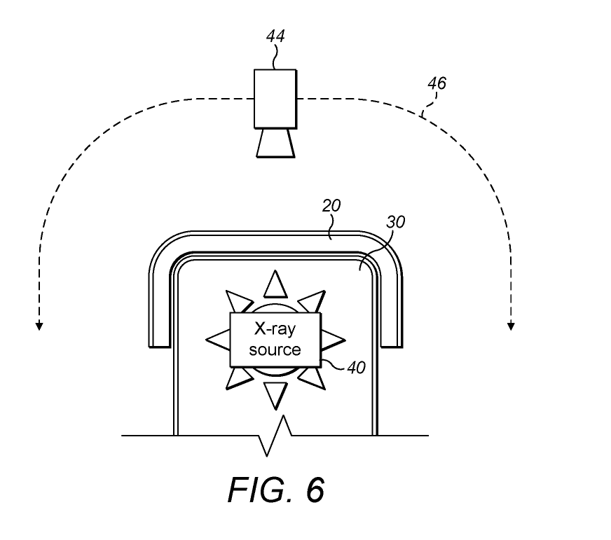

The positions of the x-ray detectable yarns 22 are determined with reference to a plurality of local coordinate systems, known as rosettes 32, formed on the tool surface of the mandrel 30. Each rosette 32 comprises a datum point 33 and three axes 34 (vectors) which indicate the expected directions of 0°, 45°, 90° and 135° fibres, respectively (only the directions for the 0°, 45° and 90° fibres are shown in FIGS. 4 and 5). The datum points 33 are each located at a point of interest associated with a geometrical feature; for example, a datum point 33 may be located at a radius or at a region between a radius and a ramp.

The mandrel 30 has a generally hollow chamber beneath the tool surface within which an x-ray source 40 is located, as shown in FIG. 5. The mandrel 30 is machined from a block of high temperature resistant material such as TB650 produced by Advanced Composites Group Ltd, or similar material, which is not detectable by x-ray, and the rosettes 32 comprise x-ray detectable material (such as barium sulphate, or Micropake™) inlaid into the tool surface. The x-ray detectable material may comprise x-ray detectable yarn (e.g. Micropake™ yarn) located within the etched rosette and embedded within a resin to achieve a smooth tool surface of the mandrel 30. Thus, an x-ray detector 44 (or other means of obtaining an x-ray exposure) can be used to produce an x-ray image 42 of the test piece which can be analysed to determine the orientation of each of the x-ray detectable yarns 22 with respect to a respective one of the rosettes 32. This analysis includes measuring the angular deviation of the yarns 22 with respect to the rosettes 32. The x-ray detector 44 is movable relative to the mandrel 30 along the trajectory indicated by the arrows 46 in FIG. 6 (and corresponding trajectories at other cross-sections, i.e. at other positions in the direction perpendicular to the plane shown in FIG. 6) in order to be capable of producing images 42 at any part of the charge 20.

In this way, the orientation of a yarn 22 representing the optimised fibre path of a fibre with a nominal 0° fibre direction can be compared with the expected orientation of such a fibre at a particular datum point 33, the expected orientation being represented by the 0° axis 34 of the rosette 34. This process can be repeated for other fibre orientations, and at different ply locations within the charge 20. For example, fibre deviations for 0° fibre paths can be determined for a ply 21 near the top of the charge 20 and a ply 21 near the middle of the charge 20. Alternatively, fibre deviations can be determined for representative 0° fibres, 45° fibres and 90° fibres at any given datum point 33.

In an alternative embodiment the orientations of the fibres are not detected by x-ray or other scanning method, such as ultrasound scanning or ultrasonic backscattering, but instead release films are arranged between successive plies 21 to enable the plies 21 of the test piece to be peeled away one by one after the hot drape forming process. Removing the plies in this way enables the angular deviations of the fibres of each ply at each datum point with respect to an expected direction to be ascertained by visual inspection. Measurement may be achieved by using a laser projector and manually measuring the angular deviation to a projected laser line at each ply.

The fibre deviations (as determined by either measurement method) can then be used to determine optimised fibre paths for 0°, 45°, 90° and 13520 fibres at each datum point 33. An optimised fibre path may correspond exactly to the fibre path indicated by the detected yarn 22, or may be selected based on analysis of measurements from a plurality of yarns 22. The fibre path indicated by the detected yarn 22 typically represents the optimised fibre path in terms of manufacturability, but it may be necessary to achieve a compromise between manufacturing needs and design constraints. The design may have to be altered in order to compensate for any loss of performance associated with the optimised fibre path, or to redesign any geometrical features which cause troublesome deviations from nominal fibre paths.

The optimised fibre paths can then be used to determine a fibre path for a composite component, such as the spar 10, which is to be formed using an automated fibre placement (AFP) process. That is, the fibre paths to be achieved during the AFP process can be based on the optimised fibre paths. In this way, it is expected that during cure of a component produced using such an optimised AFP process there will be minimal movement of the fibres, and in particular minimal or no out-of-plane movement of fibres that could cause wrinkles.

The optimised fibre paths for each of a plurality of different geometrical features (radii, joggles, ramps etc.) and combinations thereof may be compiled into a database providing a set of design rules used in the process of defining the fibre paths for a component to be produced by an AFP or HDF process.

In some embodiments the rosettes 32 represent local coordinate systems that are each related by a known relationship to a master tool coordinate system. The measured fibre deviations may be used to modify the orientations of those local coordinate systems relative to the master tool coordinate system. The modified local coordinate systems will then each represent the optimised fibre path at a respective datum point, and can be used in the process of defining the fibre paths for a component to be produced by an AFP process.

The result of the process of defining the fibre paths for an AFP-produced component is a complete set of instructions for the AFP machine to follow during lay-up of the tows over the mandrel.

Although the invention has been described above with reference to one or more preferred embodiments, it will be appreciated that various changes or modifications may be made without departing from the scope of the invention as defined in the appended claims.

1. A method of determining an optimized fiber path for a geometrical feature of a composite component comprising a plurality of layers of composite material, each layer of composite material comprising a plurality of unidirectional fibers embedded in a matrix, the method comprising:
manufacturing a test piece by laying up a plurality of composite plies to form a planar charge, each composite ply comprising a plurality of unidirectional fibers embedded within a matrix; and shaping the planar charge by forming it on a tool, the shaped charge having a shape corresponding to a geometrical feature of the composite component;
at each of one or more datum points, measuring a direction of the unidirectional fibers of one of the plurality of composite plies of the manufactured test piece with
respect to a local coordinate system of said datum point; and
determining an optimized fiber path for the geometrical feature based on the one or more measured fiber directions of said one of the plurality of composite plies.

2. The method of claim 1, wherein the layers of composite material of the composite component each comprise:
one or more tows for laying up by an automated fiber placement process; or
one or more composite plies for laying up by a drape forming process.

3. The method of claim 1, wherein the one or more of the plurality of composite plies of the test piece each include one or more detectable yarns aligned with the unidirectional fibers of that ply, and the step of measuring a direction of the unidirectional fibers includes detecting said one or more yarns and determining an angular deviation of the one or more yarns relative to each of the local coordinate systems.

4. The method of claim 3, wherein the one or more yarns comprise an x-ray detectable material, and the step of detecting said one or more yarns includes taking an x-ray image of the test piece.

5. The method of claim 1, wherein each local coordinate system comprises a reference marker formed on the mandrel, the reference marker comprising one or more vectors extending from the respective datum point.

6. The method of claim 5, wherein the rosette comprises at least one of: a vector corresponding to a 0° fiber direction; a vector corresponding to a 45° fiber direction; a vector corresponding to a 90° fiber direction; and a vector corresponding to a 135° fiber direction.

7. The method of claim 1, wherein the matrix of the composite plies of the test piece comprises a thermosetting epoxy resin.

8. The method of claim 1, wherein the matrix of the composite plies of the test piece has a pre-cure minimum dynamic viscosity of 30 Pa·s or less.

9. The method of claim 1, wherein the matrix of the composite plies of the test piece comprises substantially no un-dissolved toughener material.

10. A method of manufacturing a composite component having a geometrical feature and comprising a plurality of layers of composite material, each layer of composite material comprising a plurality of unidirectional fibers embedded in a matrix, the method including the steps of:
determining the optimized fiber path for the geometrical feature using the method of claim 1; and
laying up the plurality of layers of composite material to form the composite component, a direction of the unidirectional fibers of one or more of the layers of composite material at each datum point corresponding to the optimized fiber path.

11. The method of claim 10, wherein the matrix of the composite plies of the test piece has a lower frictional resistance to fiber movement than the matrix of the layers of composite material of the composite component.

12. The method of claim 10, wherein the composite component is a spar of an aircraft wing.

13. A method of providing a set of design rules for determining optimized fiber paths of a composite product comprising a plurality of geometrical features, the method including the steps of:
for each of the plurality of geometrical features, determining an optimized fiber path using the method of claim 1; and
compiling the optimized fiber paths of the geometrical features to provide a set of design rules for fiber paths of a composite product.

14. The method of claim 13, wherein the plurality of geometrical features includes one or more of: ramps, joggles, and radii.

15. A forming tool comprising:
a tool surface for shaping a charge formed by composite piles;
a plurality of reference markers formed on the tool surface, each reference marker including a datum point and one or more vectors extending from the datum point, and each reference marker being detectable through the charge by a scanning device.

16. The forming tool according to claim 15, wherein the reference markers are detectable by an x-ray detector.

17. The forming tool according to claim 15, wherein the tool surface comprises a male tool surface.

18. An apparatus for use with the method of claim 1, including:
a forming tool with a tool surface for shaping a charge formed by layers of composite piles;
reference markers on the tool surface, wherein each reference includes a datum point and a vector extending from the datum point, and each reference marker being detectable through the charge by a scanning device; and
a scanning device arranged to detect the references markers of the forming tool.

19. The apparatus according to claim 18, wherein the scanning device comprises an x-ray source and an x-ray detector arranged with the tool surface of the mandrel there between.
